(19) United States
(12) Patent Application Publication
(10) Pub. No.: US 2023/0153579 A1
(43) Pub. Date: May 18, 2023

(54) MULTI-GRAPH CONVOLUTION COLLABORATIVE FILTERING

(71) Applicant: HUAWEI TECHNOLOGIES CO., LTD., Shewnzhen (CN)

(72) Inventors: Jianing SUN, Montreal (CA); Yingxue ZHANG, Markham (CA); Guo Huifeng, Shenzhen (CA); Ruiming TANG, Shenzhen (CN); Xiuqiang HE, Shenzhen (CN); Dengcheng ZHANG, Shenzhen (CN); Han YUAN, Hangzhou City (CN)

(21) Appl. No.: 18/154,523

(22) Filed: Jan. 13, 2023

Related U.S. Application Data
(63) Continuation of application No. PCT/CN20/02481, filed on Jul. 16, 2020.

(51) Int. Cl. G06N 3/0464; G06N 3/08

(52) U.S. Cl. CPC G06N 3/0464; G06N 3/08

(57) ABSTRACT

Method and system for processing a bipartite graph that comprises a plurality of first nodes of a first node type, and a plurality of second nodes of a second type, comprising: generating a target first node embedding for a target first node based on features of second nodes and first nodes that are within a multi-hop first node neighbourhood of the target first node, the target first node being selected from the plurality of first nodes of the first node type; generating a target second node embedding for a target second node based on features of first nodes and second nodes that are within a multi-hop second node neighbourhood of the target second node, the target second node being selected from the plurality of second nodes of the second node type; and determining a relationship between the target first node and the target second node based on the target first node embedding and the target second node embedding.

### RELATED APPLICATIONS

This application is a continuation of and claims the benefit of International Application No. PCT/CN/2020/102481 filed Jul. 16, 2020, entitled “MULTI-GRAPH CONVOLUTION COLLABORATIVE FILTERING”, the contents of which are incorporated herein by reference.

### FIELD

This disclosure relates generally to the processing of graph based data using machine learning techniques, including processing bipartite graph data.

### BACKGROUND

Personalized recommendation plays an important role in many online services. Accurate personalized recommendation systems can benefit users as well as content publishers and platform providers. As a result, recommender systems have attracted great interest in both academia and industry. A core method behind recommender systems is collaborative filtering (CF). A common method for collaborative filtering is matrix factorization (MF). MF models characterize both items and users by vectors in the same space, inferred from the observed entries of the user-item historical interaction.

Deep learning models have been introduced in various applications recently, boosting the performance significantly compared to traditional models. However, deep learning methods are not sufficient to yield optimal user/item embeddings due of the lack of explicit encoding of the latent collaborative signal from user-item interactions and the reliance on the explicit feedback from users that are relatively sparse.

Therefore, researchers have turned to the emerging field of graph convolutional neural networks (GCNNs), and applied GCNNs for recommendation by modeling the user-item interaction as a bipartite graph. A number of recent works focus on using GCNNs to learn user and item representations for recommender systems. GCNN's are used to model the user-item interaction history as a bipartite graph and treat each user and each item as a respective node in the graph. The vector representation of a node is learned by iteratively combining the embedding of the node itself with the embeddings of the nodes in its local neighborhood. An embedding is a mapping of a discrete variable to a vector of continuous numbers. In the context of neural networks, embeddings are low-dimensional, learned continuous vector representations of discrete variables. Neural network embeddings are useful because they can reduce the dimensionality of categorical variables and meaningfully represent categories in the transformed space.

Most existing methods split the process of learning a vector representation of a node into two steps: neighborhood aggregation, in which an aggregation function operating over sets of vectors to aggregate the embeddings of neighbors, and center-neighbor combination that combines the aggregated neighborhood vector with the central node embedding. These methods learn node embeddings on graphs in a convolution manner by representing a node as a function of its surrounding neighborhood, which is similar to the receptive field of a center-surround convolutional kernel in computer vision.

Despite their effectiveness, existing GCNN bipartite graph solutions have at least two limitations. First, existing solutions ignore the intrinsic difference between the two types of nodes in the bipartite graph (users and items), and thus the heterogeneous nature of the bipartite graph has not been fully considered. Second, even if most GCNN-based recommendation models exploit the user-item relationship during embedding construction, they ignore the user-user and item-item relationships, which are also very important signals.

Accordingly there is a need for a GCNN-based recommender system that that is able take advantage of the intrinsic difference between node types of a graph (e.g., users and items) and the relationships between same-type nodes (e.g., user-user relationships, item-item relationships).

### SUMMARY

In example embodiments, a method and system is provided that may extract information from a bipartite graph data that includes two types of nodes. First, the similarity between nodes for a first type and nodes of a second type may be captured by modeling the historical interaction as a bipartite graph. Graph network generated embeddings hu, hv are derived through graph convolution over the bipartite graph representing user-item interaction. Second, similarities among nodes of the first type and nodes of the second type are identified by constructing first node type-first node type and second node type-second node type graphs. Multi-graph embeddings are derived from proximal information extracted from these same node-type graphs. In some examples, skip connection embeddings are generated to enable learning from individual node characteristics by re-emphasizing initial features.

In some applications, the method and system can be implemented to enable a recommender system that takes advantage of the intrinsic difference between node types of a graph (e.g., users and items) and the relationships between same-type nodes (e.g., user-user relationships, item-item relationships). In at least some applications, this may enable more accurate recommendations thereby improving system efficiency.

According to a first aspect is a computer implemented method for processing a bipartite graph that comprises a plurality of first nodes of a first node type, and a plurality of nodes of a second type. The method includes: generating a target first node embedding for a target first node based on features of second nodes and first nodes that are within a multi-hop first node neighbourhood of the target first node, the target first node being selected from the plurality of first nodes of the first node type; generating a target second node embedding for a target second node based on features of first nodes and second nodes that are within a multi-hop second node neighbourhood of the target second node, the target second node being selected from the plurality of second nodes of the second node type; and determining a relationship between the target first node and the target second node based on the target first node embedding and the target second node embedding.

In at least some example embodiments of the preceding aspect generating the target first node embedding comprises: for each of a plurality of second nodes included within the first node neighbourhood (i) aggregating features for first nodes that are direct neighbours of the second node within the first node neighbourhood, and mapping the aggregated features to a respective second node embedding; (ii) aggregating the second node embeddings for the plurality of second nodes included within the first node neighbourhood; and (iii) mapping the aggregated second node embeddings to generate the target first node embedding. Generating the target second node embedding comprises: for each of a plurality of first nodes included within the second node neighbourhood: (i) aggregating features for second nodes that are direct neighbours of the first node within the second node neighbourhood, and mapping the aggregated features to a respective first node embedding; (ii) aggregating the first node embeddings for the plurality of first nodes included within the second node neighbourhood; and (iii) mapping the aggregated first node embeddings to generate the target second node embedding.

In at least some examples, each aggregating and mapping is performed using a respective function that is defined by a respective set of learnable parameters, wherein the aggregating and mapping is performed iteratively in respect of the target first node and the target second node and the learnable parameters updated to optimize an objective function calculated based on the target first node embedding and the target second node embedding.

In at least some examples of the preceding aspects, the functions are implemented within a graphic convolution network (GCN) and the respective sets of learnable parameters are weight matrices.

In at least some examples of the preceding aspects, the method includes defining the first node neighbourhood of the target first node by randomly sampling the bipartite graph to: select a second node subset from second nodes that are direct neighbours of the target first node, and select respective subsets of first nodes from first nodes that are direct neighbours of each of the second nodes of the second node subset; and defining the second node neighbourhood of the target second node by randomly sampling the bipartite graph to: select a first node subset from first nodes that are direct neighbours of the target second node, and select respective subsets of second nodes from second nodes that are direct neighbours of each of the first nodes of the first node subset.

In at least some examples of the preceding aspects, respective predefined hyper-parameters define respective sizes of the second node subset, the respective subsets of first nodes, the first node subset and the respective subsets of second nodes.

In at least some examples of the preceding aspects, the method includes determining, based on the bipartite graph, first node to first node relationship information and constructing a first node graph that includes first nodes, including the target first node, from the bipartite graph and the first node to first node relationship information; generating a first node-first node embedding for the target first node based on the first node graph; determining, based on the bipartite graph, second node to second node relationship information and constructing a second node graph that includes second nodes, including the target second node, from the bipartite graph and the second node to second node relationship information; generating a second node-second node embedding for the target second node based on the second node graph; wherein the relationship between the target first node and the target second node is determined also based on the first node-first node embedding and the second node-second node embedding.

In at least some examples, determining the first node to first node relationship information comprises determining the presence or absence of a direct neighbor relationship between respective pairs of the first nodes based on calculating pairwise cosine similarities between the respective pairs of the first nodes, and determining the second node to second node relationship information comprises determining the presence or absence of a direct neighbor relationship between respective pairs of the second nodes based on calculating pairwise cosine similarities between the respective pairs of second nodes.

In at least some examples, generating the first node-first node embedding for the target first node comprises using a first node-first node aggregating function having learnable parameters to aggregate features of the first nodes that are direct neighbours of the target first node in the first node graph, and generating the second node-second node embedding for the target second node comprises using a second-node-second node aggregating function having learnable parameters to aggregate features of the second nodes that are direct neighbours of the target second node in the second node graph.

In at least some examples of the preceding aspects, the method includes generating, using a first skip connection transformation function having learnable parameters, a target first node skip connection embedding based on an initial target first node embedding; and generating, using a second skip connection transformation function having learnable parameters, a target second node skip connection embedding based on an initial target second node embedding, wherein the relationship between the target first node and the target second node is determined also based on the target first node skip connection and the target second node skip connection.

In at least some examples, the method includes determining a first node embedding by fusing the target first node embedding, the first node-first node embedding and the first node skip connection embedding; determining a second node embedding by fusing the target second node embedding, the second node-second node embedding and the second node skip connection embedding; the relationship between the target first node and the target second node being determined based on the first node embedding and the second node embedding.

In at least some examples, the first nodes represent users and the second nodes represent items, the bipartite graph includes historical user-item interaction data, the method further comprising determining an item recommendation for a user represented by the target node based on the determined relationship between the target first node and the target second node.

According to a further example aspect is a graph convolution network (GCN) for processing a bipartite graph that comprises a plurality of first nodes of a first node type, and a plurality of second nodes of a second type, the CGN being configured to: generate a target first node embedding for a target first node based on features of second nodes and first nodes that are within a multi-hop first node neighbourhood of the target first node, the target first node being selected from the plurality of first nodes of the first node type; generate a target second node embedding for a target second node based on features of first nodes and second nodes that are within a multi-hop second node neighbourhood of the target second node, the target second node being selected from the plurality of second nodes of the second node type; and determine a relationship between the target first node and the target second node based on the target first node embedding and the target second node embedding.

According to example embodiments of the preceding aspect, the CGN comprises: a first node first aggregating function configured to aggregate, for each of a plurality of second nodes included within the first node neighbourhood, features for first nodes that are direct neighbours of the second node within the first node neighbourhood; a first node first mapping function configured to map, for each of the plurality of second nodes, the features aggregated for the second node to a respective second node embedding; a first node second aggregating function configured to aggregate the second node embeddings for the plurality of second nodes included within the first node neighbourhood; a first node second mapping function configured to map the aggregated second node embeddings to generate the target first node embedding; a second node first aggregating function configured to aggregate, for each of a plurality of first nodes included within the second node, features for second nodes that are direct neighbours of the first node within the second node neighbourhood; a second node first mapping function configured to map, for each of the plurality of first nodes, the features aggregated for the first node to a respective first node embedding; a second node second aggregating function configured to aggregate the first node embeddings for the plurality of first nodes included within the second node neighbourhood; and a second node second mapping function configured to map the aggregated first node embeddings to generate the target second node embedding.

According to a further example aspect is a multi-graph convolution collaborative filtering system implemented in multiple layers of a multi-layer graph convolution neural network for learning about user-item preferences from a bipartite graph that includes user nodes, item nodes and interaction data about historical interactions between user nodes and item nodes, the system comprising: a bipartite-graph convolution network module configured to independently generate a user embedding for a target user node and an item embedding for a target item node based on the bipartite graph; a multi-graph encoder module configured to: construct a user-user graph representing similarities between user nodes included in the bipartite graph and generate an user-user embedding for the target user node based on the user-user graph; and construct an item-item graph representing similarities between item nodes included in the bipartite graph and generate an item-item embedding for the target item node based on the item-item graph; and a fusing operation configured to fuse the user embedding, user-user embedding, and to fuse the item embedding and item-item embedding to output information that represents a relationship between the target user node and the target item node.

### BRIEF DESCRIPTION OF THE DRAWINGS

Reference will now be made, by way of example, to the accompanying drawings which show example embodiments of the present application, and in which:

FIG. 1 is a block diagram illustrating an example of a bipartite graph;

FIG. 2 is a block diagram illustrating an example of a multi-graph convolutional collaborative filtering (Multi-GCCF) system according to example embodiments;

FIG. 3 is a block diagram illustrating an example of a bipartite graph convolution network (Bipar-GCN) of the Multi-GCCF system of FIG. 2; and

FIG. 4 is a flow diagram showing actions performed by Multi-GCCF system in example embodiments;

FIG. 5 is a flow diagram showing further actions performed by Multi-GCCF system in example embodiments;

FIG. 6 is a block diagram illustrating an example processing system that may be used to execute machine readable instructions to implement the system of FIG. 2.

Similar reference numerals may have been used in different figures to denote similar components.

### DESCRIPTION OF EXAMPLE EMBODIMENTS

A multi-graph convolutional collaborative filtering (Multi-GCCF) system is disclosed that may be incorporated into a graph convolution neural network (GCNN) based recommender system. As will be explained in greater detail below, in example embodiments, a Multi-GCCF system incorporates multiple graphs in an embedding learning process. The Multi-GCCF system expressively models high-order information via a bipartite user-item interaction graph, integrates proximal information from the bipartite user-item interaction graph by building and processing user-user and item-item graphs, and takes into account the intrinsic difference between user nodes and item nodes when performing graph convolution on the bipartite graph.

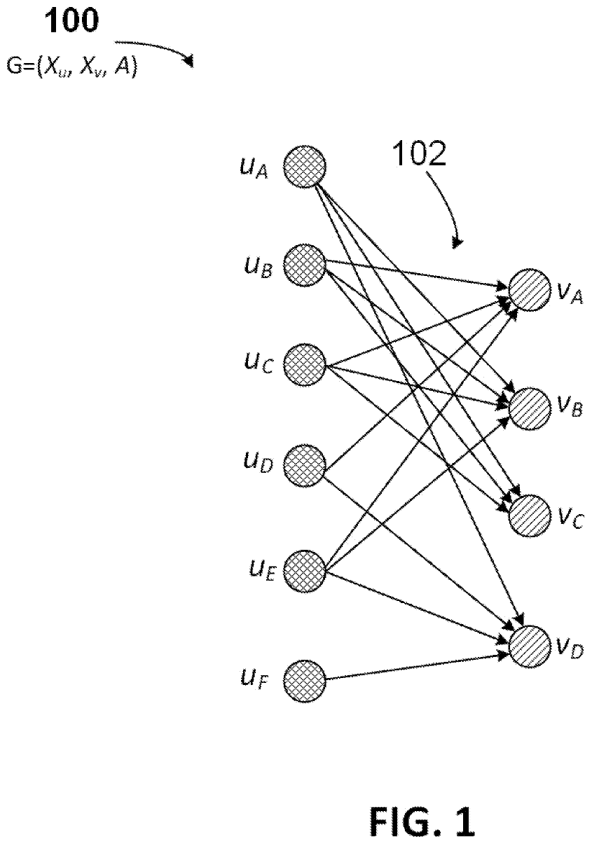

A graph is a data structure that comprises nodes and edges. Each node represents an instance or data point that is defined by measured data represented as a set of node features (e.g., a multidimensional feature vector). Each edge represents a relationship that connects two nodes. A bipartite graph is a form of graph structure in which each node belongs to one of two different node types and direct relationships (e.g., 1-hop neighbors) only exist between nodes of different types. FIG. 1 illustrates a simplified representation of a sample of a bipartite graph 100 that includes two types of nodes, namely user nodes u_{A} to u_{F} and item nodes v_{A} to v_{D}. In the present disclosure, “u” is used to refer to a generic user node or nodes and “v” is used to refer to a generic item node or nodes. Each respective user node u represents an instance of a user. For example, user node uᵢ may represent a specific user i, which may for example be the user associated with a specific registered user account or unique user identifier. Each respective item node v represents an instance of a unique item. For example item node vⱼ may represent a specific instance of an item j. Items may for example be products or services that are available to a user. For example, in some applications, items may each be a different video media item (such as a movie or series) that a user can stream or download from an online video content provider. In some applications, items may each be a different audio media item (such as a song or a podcast) that a user can stream or download from an online audio content provider. In some applications, items may each be a different image/text media item (such as new articles, magazine articles or advertisements) that a user can be provided with by an online content provider. In some applications, items may each be a different software applications that a user can download or access from an online software provider such as an app store. In some applications, items may each be a different physical products that a user can order for delivery or pickup from an online retailer. The examples of possible categories of items provided above is illustrative and not exhaustive.

In example embodiments, user nodes u_{A} to u_{F} and item nodes v_{A} to v_{F} are each defined by a respective set of node features. For example, each user node u is defined by a respective user node feature vector xᵤ that specifies a set of user node features. Each user node feature numerically represents a user attribute. Examples of user attributes may for example include user id, age, sex, relationship status, pet ownership, geographic location, etc. Each item node v is defined by a respective item node feature vector xᵥ that specifies a set of item node features. Each item node feature numerically represents an item attribute. Examples of item attributes may for example include, in the case of a movie video: id, movie title, director, actors, genre, country of origin, release year, period depicted, etc.

The edges 102 that connect user nodes u to respective item nodes v indicate relationships between the nodes. In some example embodiments, the presence or absence of an edge 102 between nodes represents the existence or absence of a predefined type of relationship between the user represented by the user node and the item represented by the item node. For example, the presence or absence of an edge 102 between a user node u and an item node v indicates whether or not a user has previously undertaken an action that indicates a sentiment for or interest in a particular item, such as “clicking” on a representation of the item or submitting a scaled (e.g., 1 to 5 star) or binary (e.g. “like”) rating in respect of the item. For example, edges 102 can represent the click or rating history between users and items. In illustrative embodiments described below, edges 102 convey binary relationship information such that the presence of an edge indicates the presence of a defined type of relationship (e.g. user i has previously “clicked” or rated/liked an item j) and the absence of an edge indicates an absence of such a relationship. However, in further embodiments edges 102 may be associated with further attributes that indicate a relationship strength (for example a number of “clicks” by a user in respect of a specific item, or the level of a rating given by a user).

In example embodiments, the bipartite user-item interaction graph 100 can be represented as G=(Xᵤ, Xᵥ, A), where Xᵤ is a feature matrix that defines the respective feature vectors xᵤ of user nodes u; Xᵥ is a feature matrix that defines the respective feature vectors xᵥ of item nodes v, and A is an adjacency matrix that defines the connections (edges 102) between user nodes u and item nodes v. In example embodiments where edges 102 convey the presence or absence of a defined relationship, adjacency matrix A can be represented as a matrix of binary values that indicate the presence or absence of a connecting edge between each user node u and each item node v. In some examples, adjacency matrix A corresponds to a “click” or “rating” matrix. Thus, bipartite graph 100 includes historical information about users, items, and the interactions between users and items.

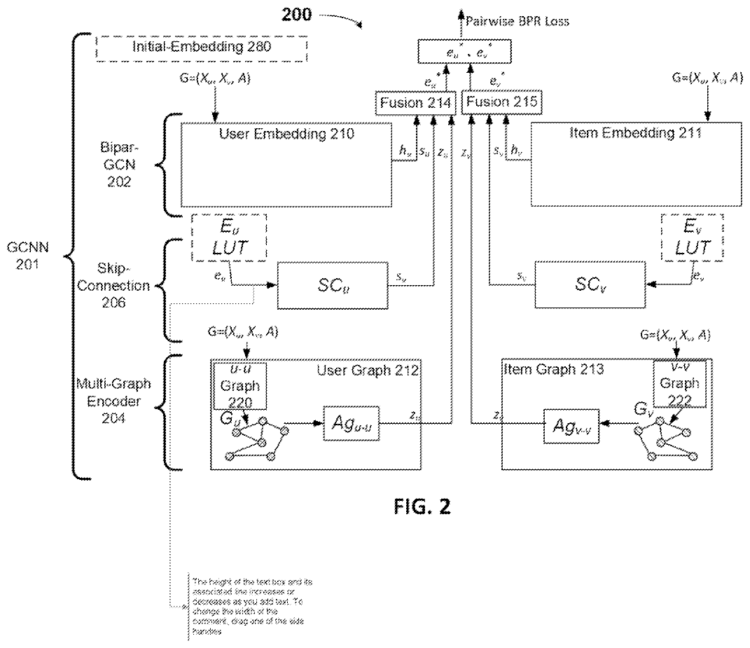

With reference to FIG. 2, example embodiments of a Multi-GCCF system 200 are disclosed that can be applied in the context of a recommender system that recommends items to specific users based on latent information that is included in a data structure such as bipartite graph 100. In example embodiments, Multi-GCCF system 200 includes multiple layers of a multi-layer GCNN 201 and is trained to learn about user preferences from bipartite graph 100. In the illustrated embodiment, Multi-GCCF system 200 includes three modules as follows. (1) Bipartite-graphic convolution network (Bipar-GCN) module 202 that is configured to act as an encoder to generate user and item embeddings hᵤ, hᵥ for user nodes u and item nodes v in bipartite graph 100. (2) Multi-graph encoder module 204 that is configured to encode latent information from bipartite graph 100 by constructing and processing multiple graphs, including a user-user graph Gᵤ that represents user-user similarities and an item-item graph Gᵥ that illustrates item-item similarities. In example embodiments user-user graph Gᵤ is processed by a user aggregation function Agᵤ₋ᵤ to output user-user embedding zᵤ for user node u, and item-item graph Gᵥ is processed by an item aggregation function Agᵥ₋ᵥ to output item-item embedding zᵥ for item node v. (3) Skip connection module 206 is configured to exploits residual latent information included in node feature vectors xᵤ, xᵥ that may not have been captured by the graph processing performed in modules 202 and 204. In example embodiments, skip connection module 206 includes a user node transformation function SCᵤ for transforming an initial user node embedding eᵤ to a transformed user node embedding sᵤ, and an item node transformation function SCᵥ for transforming an initial item node embedding eᵥ to a transformed item node embedding sᵥ. In at least some example embodiments, skip connection module 206 is optional and can be omitted from Multi-GCCF system 200.

In example embodiments, the embeddings hᵤ, sᵤ, and zᵤ generated in respect of a user node u are fused together by a user node fusing operation 214 to provide a fused user node embedding eᵤ*, and the embeddings hᵥ, sᵥ, and zᵥ generated in respect of an item node v are fused together by an item node fusing operation 215 to provide a fused item node embedding eᵥ*.

In example embodiments, initial node embeddings eᵤ, and eᵥ are derived from initial node feature vectors xᵤ, xᵥ based on an initial set of parameters or weights of GCNN 201 and stored in respective look-up tables (LUTs) Eᵤ LUT and E_{V} LUT in memory associated with Multi-GCCF system 200. Additionally, updated node embeddings are stored in look-up tables (LUTs) Eᵤ LUT and Eᵥ LUT as they are learned during stochastic gradient descent (SGD) training of GCNN 201.

The function of each of bipar-GCN module 202, multi-graph encoder module 204 and skip connection module 206 will now each be described in greater detail.

Bipartite-Graphic Convolution Network (Bipar-GCN) Module 202

Bipar-GCN module 202 is configured to act as an encoder to generate user and item embeddings hᵤ, hᵥ for target user nodes u_{A} and target item nodes v_{A} in bipartite graph 100. Bipar-GCN module 202 is configured to combine the features of a target node with the features of other nodes in a K-hop neighborhood of the target node in order to learn more general node embeddings that take into account the contextual information available from the node's neighborhood. In this regard, Bipar-GCN module 202 is configured to learn flexible user node u and item node v embeddings eᵤ and eᵥ to capture the user preference and item characteristics from the user-item interaction history that is represented in bipartite graph 100. In example embodiments, Bipar-GCN module 202 learns embeddings to encode user nodes u and item nodes v as low-dimensional vectors that summarize their interactions as determined from click or rating history. As indicated above, user nodes u and item nodes v represent different types of entities and are defined by different attributes. Accordingly, in example embodiments Bipar-GCN module 202 is configured to learn user node embeddings eᵤ and item node embeddings eᵥ separately using respective user embedding and item embedding components 210, 211.

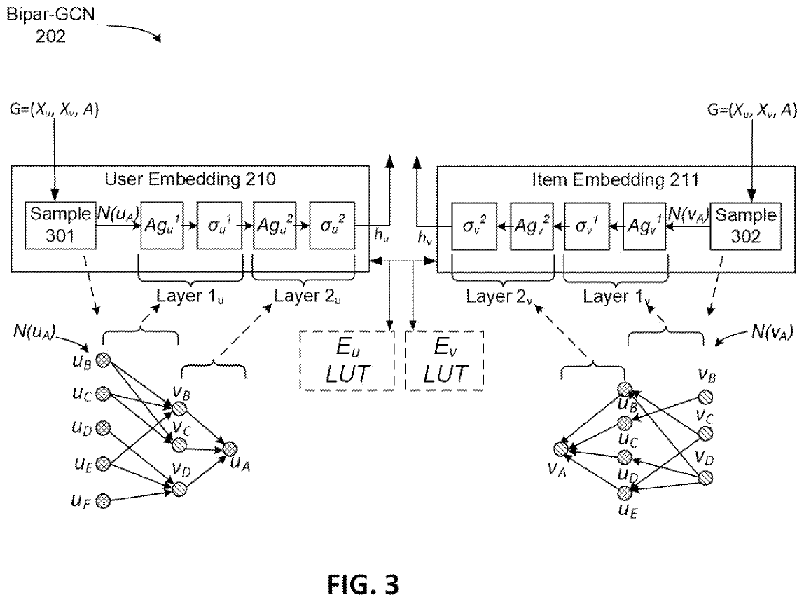

With reference to FIG. 3, user embedding component 210 and item embedding component 211 of Bipar-GCN module 202 will now be explained in greater detail according to example embodiments. User embedding component 210 and item embedding component 211 perform respective operations in the context of a target user node u_{A}, target item node v_{A} pair with an objective of learning a relationship between the nodes. Referring briefly to FIG. 1, in the illustrative example user node u_{A} and item node v_{A}, in observed bipartite graph 100 (G=(Xᵤ, Xᵥ, A)) have an unknown relationship (e.g. there is no edge connecting them), and are used as representative target nodes in the present description.

Referring again to FIG. 3, user embedding component 210 and item embedding component 211 each perform similar operations, however user embedding component 210 performs operations from the perspective of the K-hop neighborhood of target user node u_{A} and item embedding component 211 performs operations from the perspective of the K-hop neighborhood of target item node v_{A}.

The operation of user embedding component 210 will first be described. As indicated in FIG. 3, user embedding component 210 comprises a forward sampling function 301 for sampling a K-hop neighborhood of target user node u_{A}. In the illustrated embodiment, K=2 and all direct (i.e., 1^{st} hop, k=1) neighbors of target user node u_{A} are item nodes v and all 2^{nd} hop, k=2 neighbors are other user nodes u. In example embodiments, sampling function 301 is configured to address the high likelihood that bipartite graph 102 will include long-tail degree distributions. For example, some popular items will have many interactions with users while other items may have very few. However, user relationships with unpopular item nodes may carry important latent information that will be omitted from processing if unpopular nodes are overlooked. Accordingly, in example embodiments, sampling function 301 is performed avoid popular node bias and mitigate against overlooking non-popular nodes. To avoid bias, sampling function 301 randomly samples a fixed number of neighbor nodes for each node to define a resulting sample node neighborhood N(u_{A}) for target user node u_{A}. By way of illustrative example, FIG. 3 shows a graphical illustration for sample node neighborhood N(u_{A}) for target user node u_{A} that corresponds to the subset of bipartite graph 100 illustrated in FIG. 1. In example embodiments, when defining sample node neighborhood N(u_{A}) for target user node u_{A}, sampling function 301 randomly samples up to a predefined number of item nodes v that are direct neighbors of target user node u_{A} (N^{k=1}(u_{A})={v_{B},v_{C},v_{D}} in illustrated example), and then for each of the selected item nodes v, randomly samples up to a predefined number of user nodes u (other than the target user node u_{A}) that are direct neighbors of that item node v (e.g., in the illustrated example: N^{k=1}(v_{A})={u_{B},u_{C},u_{D}}, N^{k=1}(v_{C})={u_{B},u_{C}}, N^{k=1}(v_{D})={u_{D},u_{E},u_{F}}). In example embodiments, the predefined number of item nodes v that are randomly sampled and the predefined number of user nodes u that are randomly sampled for inclusion in sample user node neighborhood N(u_{A}) are predefined hyper-parameters.

Following sampling of the neighbors of the target user node u_{A} from layers 1 to K by sampling function 301, user embedding component 210 encodes target user node u_{A} by iteratively aggregating the K-hop neighborhood information using graph convolution to learn function parameters (e.g., weight transformation matrices). More particularly, in example embodiments, user embedding component 210 is implemented using K layers (Layer 1ᵤ and Layer 2ᵤ in FIG. 3) of the multi-layer GCNN 201. Layer 1ᵤ implements an aggregation function Agᵤ¹ that aggregates features from neighboring user nodes u for each item node v∈N(u_{A}) to generate a neighborhood embedding h_{N(v)} for each item node v, and a transformation function σᵤ¹ to map the item node neighborhood embeddings h_{N(v)} to respective embeddings h′ᵥ for each item node. Layer 2, performs a further aggregation function Agᵤ² that aggregates the embeddings h′ᵥ from the item node neighbors of target user node u_{A} to generate a neighborhood embedding h_{N(uA)} for target user node u_{A} and a further transformation function σᵤ² to map the target node neighborhood embedding h_{N(uA)} to a respective target node embedding hᵤ.

In example embodiments, each of the Layer 1ᵤ and Layer 2ᵤ functions Agᵤ¹, σᵤ¹, Agᵤ² σᵤ² are machine learning functions and have respective learnable function parameters, namely weight transformation matrices W¹², W¹¹, W²², and W²¹. In example embodiments, all of the learnable function parameters of multi-GCCN system 200 (including weight transformation matrices W¹², W¹¹, W²², and W²¹, and further matrices described below) are initialized with predetermined initialization parameters.

In example embodiments, the Layer 1ᵤ aggregation function Agᵤ¹ is performed for each of the item nodes v∈N(u_{A}) (e.g. N^{k=1}(u_{A})={v_{B},v_{C},v_{D}} in illustrated example) using an element-wise weighted mean aggregator that can be represented by equation (1):

h_{N(v)}=MEAN({h_{u′}⁰·W¹²,∀u′∈N(v)}) Eq. (1)

where hᵤ⁰, denotes initial embedding eᵥ, for user node u′, which is taken from the user embedding lookup table Eᵤ LUT, and “·” represents a matrix multiplication operation.

The Layer 1, transformation function σᵤ¹ to map the learned neighborhood embeddings h_{N}(V) to respective item node embeddings h′ᵥ for each item node v∈N(u_{A}) can be represented by equation (2):

h′ᵥ=σ(W¹¹·[hᵥ⁰;h_{N(v)}]) Eq. (2)

Where: hᵥ⁰ denotes the initial embeddings for the subject item node v (taken from the item node embedding lookup table Eᵥ LUT), “;” represents concatenation, and σ(·) is the tanh activation function. In example embodiments, the Layer 2ᵤ aggregation function Agᵤ² that will be performed to aggregate item node embeddings h′ᵥ for the item nodes v∈N(u_{A}) (e.g. N^{k=1}(u_{A})={v_{B},v_{C},v_{D}} in illustrated example) is also an element-wise weighted mean aggregator that can be represented by equation (3):

h_{N(u}_{_{A}}₎=MEAN({h′ᵥ·W²²,∀v∈N(u_{A})}) Eq. (3)

The Layer 2, transformation function σᵤ² to map the learned neighborhood embedding h_{N(UA)} to a target user node embedding hᵤ can be represented by equation (4):

hᵤ=σ(W²¹·[h_{N(u}_{_{A}}₎;hᵤ⁰]) Eq. (4)

where: hᵤ⁰ denotes initial embeddings eᵤ for target user node uA (taken from the user node embedding lookup table Eᵤ LUT), “;” represents concatenation, and σ(·) is the tanh activation function.

In example embodiments, the embedding hᵤ of only the target user node u_{A} is updated in the user node embedding look up table Eᵤ LUT by user embedding component 210 during each iteration of a training procedure.

As indicated above, user embedding component 210 relies on initial node embeddings hᵤ⁰,hᵥ⁰ that are obtained from stored lookup tables. In an example embodiments, initial user node embedding hᵤ⁰ is an initial embedding generated by user embedding component 210 when weights W¹², W¹¹, W²², and W²¹ are initialized, and may for example be generated using a standard initialization process such as a Xavier initialization. The user embedding is a vector having a pre-defined number of dimensions. The number of dimensions may for example be a hyper-parameter. In example embodiments the initial item node embedding hᵥ⁰ may be set in a similar manner.

The initial user node embedding hᵤ⁰, and initial item node embedding hᵥ⁰ are updated in Eᵤ LUT and Eᵥ LUT during the stochastic gradient descent (SGD) training of the GCNN 201 layers that implement user embedding component 210 and the item embedding component 211.

As noted above, item embedding component 211 operates in a similar manner as user embedding component 210, but from the perspective of target item node v_{A}. In this regard item embedding component 211 comprises a forward sampling function 302 for sampling a K-hop neighborhood of target item node v_{A}. In the illustrated embodiment, K=2 and all direct (i.e., 1^{st} hop, k=1) neighbors of target item node v_{A} are user nodes u and all 2^{nd} hop, k=2 neighbors are other item nodes v. Again, sampling function 302 is configured to mitigate against favoring popular nodes over unpopular nodes and by randomly sampling a fixed number of neighbors nodes for each node to define a resulting sample node neighborhood N(v_{A}) for target item node v_{A}. When defining sample node neighborhood N(v_{A}) for target item node v_{A}, sampling function 302 randomly selects up to a predefined number of user nodes u that are direct neighbors of target item node v_{A} (N^{k=1}(v_{A})={u_{B},u_{C},u_{D},u_{E}} in illustrated example), and then for each of the sampled user nodes u, randomly samples up to a predefined number of item nodes v (other than the target item node v_{A}) that are direct neighbors of that user node u (e.g., in the illustrated example: N^{k=1}(u_{B})={v_{C},v_{D}}, N^{k=1}(u_{C})={v_{B},v_{C}}, N^{k=1}(u_{D})={v_{C},v_{D},} and N^{k=1}(u_{E})={v_{C},v_{D}}). In example embodiments, the predefined number of user nodes u that are randomly selected and the predefined number of item nodes v that are randomly selected for inclusion in sample item node neighborhood N(v_{A}) are predefined hyper-parameters.

In example embodiments, item embedding component 211 is also implemented using K layers (Layer 1ᵥ and Layer 2ᵥ) of the multi-layer GCNN 201. Layer 1ᵥ implements an aggregation function Agᵥ¹ that aggregates features from neighboring item nodes v for each user node u∈N(v_{A}) to generate a neighborhood embedding h_{N}(u) for each user node u, and a transformation function σᵥ¹ to map the neighborhood embeddings h_{N(u)} to respective embeddings h′ᵤ for each user node. Layer 2ᵥ performs a further aggregation function Agᵥ² that aggregates the embeddings h′_{U} from the user node neighbors of target item node v_{A} to generate a neighborhood embedding h_{N(vA)} for target item node v_{A} and a further transformation function σᵥ² to map the target node neighborhood embeddings h_{N(vA)} to a respective target node embedding hᵥ.

In example embodiments, each of the Layer 1ᵥ and Layer 2ᵥ functions AGᵥ¹, σᵥ¹, AGᵥ², σᵥ² are machine learning functions and have respective learnable function parameters, namely weight transformation matrices Q²², Q¹¹, Q²², and Q²¹. The Layer 1ᵥ and Layer 2ᵥ functions of item embedding component 211 are used to encode target item node v_{A} by iteratively aggregating K-hop neighborhood information using graph convolution to learn the weight transformation matrices.

In example embodiments, the Layer 1ᵥ aggregation function AGᵥ¹ is performed for each of the user nodes u∈N(v_{A}) (e.g. N^{k=1}(v_{A})={u_{B},u_{C},u_{D},u_{E}} in illustrated example) using an element-wise weighted mean aggregator that can be represented by equation (5):

h_{N(u)}=MEAN({h_{v′}⁰,·Q¹²,∀v′∈N(u)}) Eq. (5)

where hᵥ⁰, denotes initial embeddings e_{v′} for item node v′, which is taken from the item embedding lookup table Eᵥ LUT, and “·” represents matrix multiplication. For each user node u∈N(v_{A}), the Layer 1ᵥ transformation function σᵥ¹ for mapping the learned neighborhood embeddings h_{N(u)} to respective user node embeddings h′ᵤ for each user node u∈N(v_{A}) can be represented by equation (6):

h′ᵤ=σ(Q¹¹·[hᵤ⁰;h_{N(u)}]) Eq. (6)

where: hᵤ⁰ denotes the embeddings for the subject user node u (taken from the user node embedding lookup table Eᵤ LUT), “;” represents concatenation, “·” represents matrix multiplication and σ(·) is the tanh activation function.

In example embodiments, the Layer 2ᵥ aggregation function Qᵥ² that will be performed to aggregate user node embeddings h′ᵤ for the user nodes u∈N(v_{A}) (e.g. N^{k=1}(v_{A})={u_{B},u_{C},u_{D},u_{E}} in illustrated example) is also an element-wise weighted mean aggregator that can be represented by equation (7):

h_{N(v}_{_{A}}₎=MEAN({h′ᵤ·Q²²,∀u∈N(v_{A})}) Eq. (7)

The Layer 2ᵥ transformation function σᵥ² to map the learned neighborhood embedding h_{N(vA)} to a target item node embedding hᵥ can be represented by equation (8):

hᵥ=σ(Q²¹·[h_{N(v}_{_{A}}₎;hᵥ⁰]) Eq. (8)

where: hᵥ⁰ denotes initial embeddings eᵥ for target item node v_{A} (taken from the item node embedding lookup table Eᵥ LUT), “;” represents concatenation, and σ(·) is the tanh activation function.

In example embodiments, the embedding hᵥ of only the target item node v_{A} is updated in the item node embedding look up table Eᵥ LUT by user embedding component 211 during each iteration of a training procedure.

Multi-Graph Encoder module

Referring again to FIG. 2, as noted above, multi-graph encoder module 204 encodes latent information from bipartite graph 100 (G=(Xᵤ, Xᵥ, A) by constructing and processing multiple graphs, including a user-user graph Gᵤ that represents user-user similarities and an item-item graph Gᵥ that illustrates item-item similarities. In this regard, multi-graph encoder module 204 includes a user graph component 212 for constructing and processing user-user graph Gᵤ and an item graph component 213 for constructing and processing item-item graph Gᵥ. User graph component 212 includes a user-user graph construction function 220 that constructs user-user graph Gᵤ and a user aggregation function Agᵤ₋ᵤ to output user-user embedding zᵤ for target user node U_{A}. Different graph construction methods can be applied by user-user graph construction function 220 to construct user-user graph Gᵤ from the information included in bipartite graph G. In one example embodiment, user-user graph construction function 220 is configured to construct a user-user graph Gᵤ by computing pairwise cosine similarities on the rows or columns of the adjacency matrix A (which as noted above corresponds to a rating/click matrix in the illustrated embodiment), in order to capture the proximity information among user nodes u. By way of example, for each user node u, an item node connection vector can be built that identifies all the item nodes v that the user node U is connected to. The cosine similarity of this item node connection vector for every user-user pair can then be calculated to determine user similarity. For example, for a user node uᵢ, cossim(uᵢ, uⱼ) is computed where j is the index for all other user nodes. Then for user node i, similarity scores are obtained verses every other user node. The higher the score, the higher the similarity. A similarity matrix is constructed that includes a similarity score for every user-user node pair. Then, for each user node, a predefined number (degree) of other user nodes (e.g. degree=10) with the highest similarity scores are selected as direct neighbors for the user-user graph.

Unlike the Bipar-GCN module 202, in example embodiments additional neighbor sampling is not performed in user-user graph construction function 220 because the constructed user-user graph Gᵤ will typically not have a long-tailed degree distribution. In a non-limiting example embodiment, the thresholds for cosine similarity is selected to provide an average degree of 10 connections for each user-user graph Go.

User aggregation function Agᵤ₋ᵤ is learnable function configured to output a target user node embedding zᵤ that is an aggregation of the user node embeddings over all direct user node neighbors of target user node u_{A} in the user-user graph Gᵤ. In example embodiments, user aggregation function Agᵤ₋ᵤ can be implemented to perform the learnable function represented by Equation (9):

zᵤ=σ(Σ_{iϵN′(u}_{_{A}}₎eᵤⁱ·Mᵤ) Eq. (9)

where: σ is the tanh activation functions, N′(u_{A}) denotes the one-hop neighborhood of target user node u_{A} in the user-user graph Gᵤ, Mᵤ are learnable function parameters (e.g., a learnable user aggregation weight matrix), and eᵤⁱ is the node embedding, taken from user node embedding look-up-table Eᵤ LUT, for neighbor user node uᵢ
Item graph component 213 is similar in configuration to user graph component 212. Item graph component 213 includes an item-item graph construction function 222 that constructs item-item graph Gᵥ and an item aggregation function Agᵥ₋ᵥ to output item-item embedding zᵥ for target item node v_{A}. In example embodiments, item-item user graph construction function 222 is also configured to construct item-item graph Gᵥ by computing pairwise cosine similarities on the rows or columns of the adjacency matrix A in order to capture the proximity information among item nodes v. A threshold (which may be a predetermined hyper-value) is applied to the cosine similarity calculated in respect of each item node pair to determine if an edge is present or not between the respective item nodes in the resulting item-item graph Gᵥ. In a non-limiting example embodiment, the thresholds for cosine similarity is selected to provide an average degree of 10 for each item-item graph Gᵥ.

Item aggregation function Agᵥ₋ᵥ is also a learnable function and is configured to output a target item node embedding zᵥ that is an aggregation of the item node embeddings over all direct item node neighbors of target item node v_{A} in the item-item graph Gᵥ. In example embodiments, user aggregation function Agᵥ₋ᵥ can be implemented to perform the learnable function represented by Equation (10):

zᵥ=σ(Σ_{jϵN′(v}_{_{A}}₎eᵥ^{j}·Mᵥ) Eq. (10)

where: N′(v_{A}) denotes the one-hop neighborhood of target item node v_{A} in the item-item graph Gᵥ, Mᵥ are learnable function parameters (e.g., a learnable user aggregation weight matrix), and eᵥ^{j} is the node embedding, taken from item node embedding look-up-table Eᵥ LUT, for neighbor item node vⱼ.

In example embodiments, user aggregation function Agᵤ₋ᵤ and item aggregation function Agᵥ₋ᵥ are each implemented using respective layers of the multi-layer GCNN 201.

Skip Connection Module

In the embodiments described both Bipar-GCN module 202 and multi-graph encoder module 204 focus on learning node embeddings based on relationships. As a result, the impact of the initial node features on the final embedding becomes indirect. In example embodiments, skip connection module 206 is included in multi-GCCN system 200 to provide skip connections to re-emphasize the initial node features. Skip connections can be used in a convolution neural network to directly copy information that is available in the primary layers to later layers. In some applications, these skip connections may enable multi-GCCN system 200 to take into account information that may be overlooked due to the focus of Bipar-GCN module 202 and multi-graph encoder module 204 on relationships through graph processing. In this regard, skip connection module 206 can exploit residual latent information included in node feature vectors xᵤ, xᵥ that may not have been captured by the graph processing performed in Bipar-GCN module 202 and multi-graph encoder module 204.

Accordingly, in example embodiments, skip connection module 206 is configured to supplement the embeddings hᵤ,sᵤ,hᵥ,sᵥ learned by Bipar-GCN module 202 and multi-graph encoder module 204 with information passed directly from original embeddings eᵤ, eᵥ of node feature vectors xᵤ, xᵥ.

In an example embodiments, initial embeddings eᵤ, eᵥ derived from node feature vectors xᵤ, xᵥ are respectively taken from embedding look-up tables Eᵤ LUT and Eᵥ LUT and processed by respective skip connection transformation functions SCᵤ and SCᵥ. Skip connection transformation functions SCᵤ and SCᵥ are each implemented using a single fully-connected layer to generate respective skip-connection embeddings sᵤ, sᵥ. In an example embodiment, skip connection transformation functions SCᵤ and SCᵥ are learnable functions respectively represented by equations (11) and (12) as follows:

zᵤ=σ(eᵤ·Sᵤ) Eq. (11)

zᵥ=σ(eᵥ·Sᵥ) Eq. (12)

where: σ is the tanh activation function; and Sᵤ, Sᵥ are each learnable weight transformation matrices.

### Information Fusion

In at least some applications, the embeddings learned by Bipar-GCN module 202, multi-graph encoder module 204 and skip connection module 206 may reveal latent information from three perspectives. First, the Bipar-GCN module 202 captures behavioral similarity between user nodes and item nodes by explicitly modeling the historical interaction as a bipartite graph. Bipar-GCN generated embeddings hu, hᵥ are derived through graph convolution over the bipartite graph 102 representing user-item interaction. Second, the multi-graph encoder module 204 identifies similarities among user nodes and item nodes by constructing user-user and item-item graphs. Multi-graph encoder generated embeddings zᵤ, zᵥ are derived from proximal information extracted from user-user and item-item graphs. Third, the skip connection module 206 allows learning from individual node characteristics by re-emphasizing initial features. Skip connection generated embeddings sᵤ, sᵥ are derived directly from individual node features.

To exploit these three perspectives, multi-GCCN system 200 includes user node fusing module 214 configured to perform a user node fusion operation for fusing the embeddings hᵤ, sᵤ, and zᵤ to provide a fused user node embedding eᵤ*, and item node fusing module 215 configured to perform an item node fusion operation for fusing the embeddings hᵥ, sᵥ, and zᵥ to provide a fused item node embedding eᵥ*.

In different examples embodiments, different fusing functions may be used, including for example element-wise sum, concatenation and attention functions as represented in the context of user node embeddings in the following table (1) (the same functions can also be used in respect of item node embeddings):

TABLE 1
Fusion options.

| | Formula |
|---|---|
| Element-wise sum | e [symbol] = h [symbol] + z [symbol] + s [symbol] |
| Concatenation | e [symbol] = [h [symbol] z [symbol] s [symbol] ] |
| Attention | A [symbol] = Softmax(W [symbol] (W [symbol] ·h [symbol] + W [symbol] · z [symbol] + |
| | W [symbol] · s [symbol] )) e [symbol] = [h [symbol] z [symbol] s [symbol] ] · A [symbol] |

[symbol]

indicates data missing or illegible when filed

In the example described above, the target item node v_{A} is described as a node that is not a direct neighbor of target user node u_{A}. However, in some examples the target item node v_{A} can be an item node that is a direct neighbor of target user node u_{A}. In example embodiments, the items nodes v that are direct neighbors (e.g., have a pre-existing edge connection) with a user node are “positive” nodes with respect to that user node, and other item nodes that are not direct neighbors (e.g., do not have a pre-existing edge connection) with a user node are “negative” nodes with respect to that user node.

Training

In the example embodiments illustrated above, node embeddings eᵤ*, eᵥ* are learned at the same time as function parameters (e.g., weight matrices W12, W11, W22, W21, Q12, Q11, Q22, Q21, Mᵤ, Mᵥ Su, and Sv) of multi-GCCF system 200. In example embodiments, multi-GCCF system 200 is configured to be trained using forward and backward propagation for mini-batches of triplet pairs {u, i, j}. In this regard, unique user node u and item node v ({i,j}) (where i refers to an item node v that is a positive node with respect to user node u and, j refers to an item node v that is a negative node with respect to user node u) are selected from min-batch pairs and then processed to obtain low-dimensional embeddings {eᵤ, eᵢ, eⱼ} after information fusion, with stochastic gradient descent on the pairwise Bayesian Personalized Ranking (BPR) loss for optimizing recommendation models. A BPR (Bayesian Personalized Ranking) loss, as indicated in in Equation 13 below, is computed for every triplet (user, positive item, negative item): for every user node, an item node having an existing connecting edge with the user node is a positive item, while the negative item is randomly sampled from all the other items. In the loss equation, eᵤ* represents the final output embedding of a user node, eᵢ* represents the embedding of the positive item node, and eⱼ* represents the embedding of the negative item node. The values in the second line of Equation 13 are regularization terms. The BPR loss function is configured to push the positive items closer to the user in the latent space, and other (negative) items further from the user. The “•” represents dot product (between two embeddings).

The objective BPR loss function is as follows (Equation 13):

$$loss = {\sum }_{( u , i , j ) ∈ 𝒪} - log σ ( {e}_{u}^{⋆} \cdot {e}_{i}^{⋆} - {e}_{u}^{⋆} \cdot {e}_{j}^{⋆} ) + λ {‖ Θ ‖}_{2}^{2} + β ( {‖ {e}_{u}^{⋆} ‖}_{2}^{2} + {‖ {e}_{i}^{⋆} ‖}_{2}^{2} + {‖ {e}_{j}^{⋆} ‖}_{2}^{2} ) \qquad Eq . ( 13 )$$

Where: [symbol] ={(u, i, j)|(u, i)∈ [symbol] ⁺, (u, j)∈ [symbol] ⁻)} denotes the training batch. R′ indicates observed positive interactions. R⁻ indicates sampled unobserved negative interactions; Θ is the model parameter set and e*ᵤ, e*ⱼ, and e*ⱼ are the learned embeddings; Regularization is conducted on function parameters and generated embeddings to prevent overfitting; and the regularization terms are parameterized by λ and β and respectively.

The result of the BPR loss function is used to determine weight adjustments that are back propagated through the layers of the multi-GCCF system 200.

Recommendation Predictions

Recommendation predictions are obtained based on the generated user and item embeddings. For example, for a user node u, a respective dot product can be obtained for the user node embedding eᵤ* and each item embedding eᵥ*. The dot products provide respective scores of that user node to all other item nodes. An item ranking for a user node can be determined based on the scores, and the top K ranked items selected as recommendations.

In some example embodiments, neighborhood dropout is applied to mitigate against overfitting by performing message dropout on the aggregated neighborhood features for each target node, thereby making embeddings more robust against the presence or absence of single edges.

Fusing the outputs hᵤ, hᵥ of the Bipar-GCN module 202 and the respective outputs zᵤ, zᵥ of the Multi-graph encoding module may in some applications enable the different dependency relationships encoded by the three graphs (bipartite graph G, user-user graph Gᵤ, and item-item graph Gᵥ) to be used to learn a relationship between target user node u_{A} and target item node uᵥ. In example embodiments, all three graphs can be easily constructed from historical interaction data alone without requiring side data or other external data features. Further fusing the skip connection module outputs sᵤ, sᵥ enables original feature vector information from the user and item nodes to be used when learning the relationship between target user node u_{A} and target item node uᵥ.

In at least some examples, the multi-GCCN system 200 may enable an unknown relationship between two different nodes types to be estimated with greater accuracy and/or using less computational resources (e.g., one or more of memory, processor operations, or power) than other recommender solutions.

In some applications, the input data representing user nodes u and item nodes v may be characterized by high-dimensional categorical features that are sparsely populated for most nodes. Accordingly in some embodiments, a layer of GCNN 201 may be configured to perform an initial embedding operation 280 (shown in dashed lines in FIG. 2) that is configured to generate lower dimensional, denser feature vector representations of user nodes u and item nodes v that can then be processed by modules 202, 204, 206.

Operational Overview

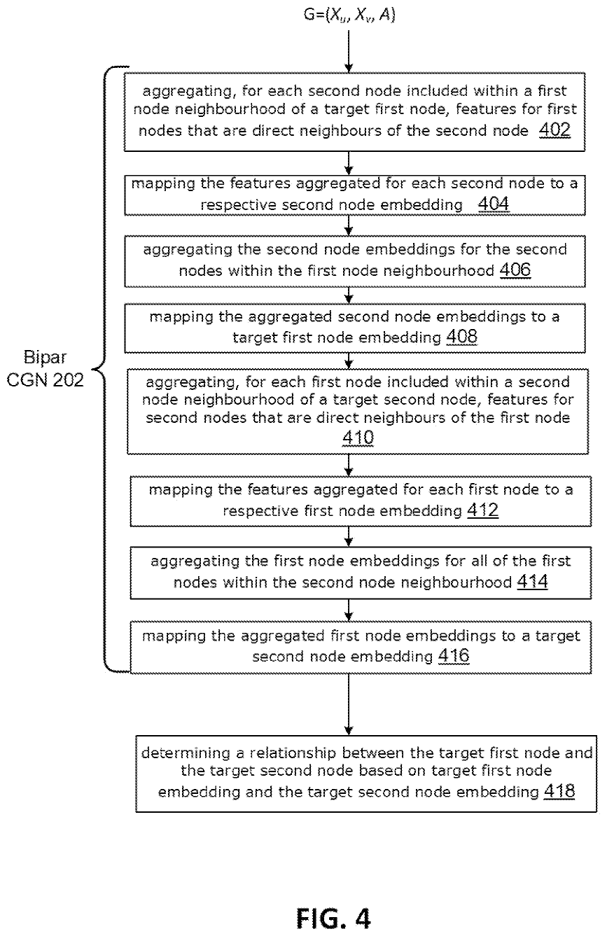

An overview of the operation of multi-GCCN system 200 according to example embodiments will now be described with reference to the flowchart of FIG. 4. The above description has described multi-GCCN system 200 in the context of a user-item bipartite graph recommender system. However, multi-GCCN system 200 may also be configured to learn embeddings that represent relationships between nodes of a first type and nodes of a second type that may not be user nodes and item nodes. Accordingly, the following overview is provided in a more generic context of a first node type and a second node type.

In example embodiments, multi-GCCN system 200 is configured to predict node relationships for nodes in a bipartite graph G that comprises a plurality of first nodes of a first node type (e.g. user nodes u), and a plurality of nodes of a second type (e.g. item nodes v). In this regard, multi-GCCN system 200 includes a Bipar-GCN module that performs the actions set out FIG. 4. A first node embedding module (e.g. user embedding module 210) is configured to perform the actions: aggregating, for each second node included within a first node neighbourhood of a target first node, features for first nodes that are direct neighbours of the second node within the first node neighbourhood (block 402); mapping the features aggregated for each second node to a respective second node embedding (block 404); aggregating the second node embeddings for the second nodes within the first node neighbourhood (block 406); mapping the aggregated second node embeddings to a target first node embedding (block 408).

A second node embedding module (e.g. item embedding module 211) is configured to perform the actions: aggregating, for each first node included within a second node neighbourhood of a target second node, features for second nodes that are direct neighbours of the first node within the second node neighbourhood (block 410); mapping the features aggregated for each first node to a respective first node embedding (block 412); aggregating the first node embeddings for all of the first nodes within the second node neighbourhood (block 414); mapping the aggregated first node embeddings to a target second node embedding (block 416).

The multi-GCCN system 200 also determines a relationship between the target first node and the target second node based on the target first node embedding and the target second node embedding (block 418).

In example embodiments, each aggregating and mapping is performed using a respective function that is defined by a respective set of learnable parameters (e.g., weight matrices), wherein the aggregating and mapping is performed iteratively in respect of the target first node and the target second node and the learnable parameters updated to optimize an objective function based on the fusing of the target first node embedding and the target second node embedding.

In example embodiments, the user embedding module 210 includes a first node sampling function 310 that performs the following actions: defining the first node neighbourhood of the target first node by randomly sampling the bipartite graph to: select a second node subset from second nodes that are direct neighbours of the target first node, and select respective subsets of first nodes from first nodes that are direct neighbours of each of the second nodes of the second node subset. The user embedding module 210 includes a second node sampling function 311 that performs the following actions: defining the second node neighbourhood of the target second node by randomly sampling the bipartite graph to: select a first node subset from first nodes that are direct neighbours of the target second node, and select respective subsets of second nodes from second nodes that are direct neighbours of each of the first nodes of the first node subset.

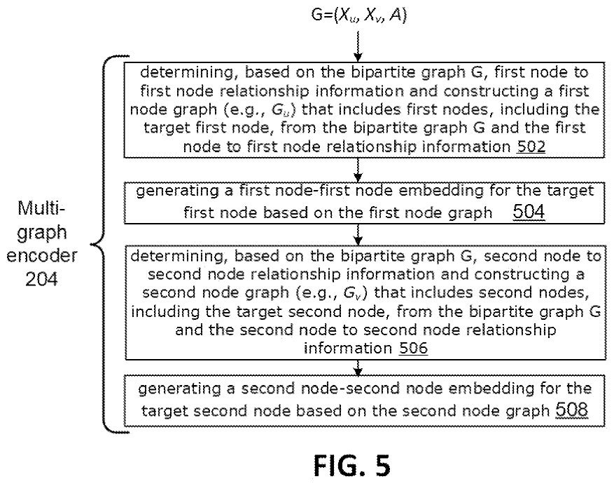

Referring to FIG. 5, in example embodiments, the multi-GCCF 200 includes a multi-graph encoder module 204 that includes a first graph operation (e.g., user graph operation 212) and a second graph operation (e.g. item graph operation 213). The first graph operation 212 performs the following actions: determining, based on the bipartite graph G, first node to first node relationship information and constructing a first node graph (e.g., Gᵤ) that includes first nodes, including the target first node, from the bipartite graph G and the first node to first node relationship information (action 502); and generating a first node-first node embedding for the target first node based on the first node graph (action 504). The second graph operation 213 performs the following actions: determining, based on the bipartite graph, second node to second node relationship information and constructing a second node graph that includes second nodes, including the target second node, from the bipartite graph and the second node to second node relationship information (action 506); and generating a second node-second node embedding for the target second node based on the second node graph (action 508). In some examples, in Action 502, determining the first node to first node relationship information comprises determining the presence or absence of a direct neighbor relationship between respective pairs of the first nodes based on calculating pairwise cosine similarities between the respective pairs of the first nodes, and in Action 506, determining the second node to second node relationship information comprises determining the presence or absence of a direct neighbor relationship between respective pairs of the second nodes based on calculating pairwise cosine similarities between the respective pairs of second nodes.

In some examples, in Action 504, generating the first node-first node embedding for the target first node comprises using a first node-first node aggregating function having learnable parameters to aggregate features of the first nodes that are direct neighbours of the target first node in the first node graph, and, in Action 508, generating the second node-second node embedding for the target second node comprises using a second-node-second node aggregating function having learnable parameters to aggregate features of the second nodes that are direct neighbours of the target second node in the second node graph.

In embodiments that include multi-graph encoder module 204, in Action 418, the relationship between the target first node and the target second node is determined also based on the first node-first node embedding and the second node-second node embedding.

In some example embodiments, multi-GCCN system 200 also includes a skip connection module 206 that generates, using a first skip connection transformation function having learnable parameters, a target first node skip connection embedding based on an initial target first node embedding; and generates, using a second skip connection transformation function having learnable parameters, a target second node skip connection embedding based on an initial target second node embedding.

In embodiments that include multi-graph encoder module 204 and skip connection module, in Action 418, the relationship between the target first node and the target second node is determined based on a fusing of the target first node embedding, the first node-first node embedding and the first node skip connection embedding; and a fusing of the target second node embedding, the second node-second node embedding and the second node skip connection embedding.

As noted above, in some example applications, the first nodes represent users and the second nodes represent items, the bipartite graph includes historical user-item interaction data, and the actions also include determining an item recommendation for a user represented by the target node based on the determined relationship between the target first node and the target second node.

Pairwise Neighbourhood Aggregation (PNA) Graph Convolution Laver

In the embodiments described above, Bipar-CGN module 202 aggregator functions AGᵤ¹ and AGᵥ¹ are implemented as mean aggregators. In other example embodiments, alternative aggregator functions can be used.

The neighborhood aggregation step in a graph convolution layer operates over sets of vectors to aggregate the embeddings of neighbors. In an aggregator function according to an alternative example, each neighbor node is considered as a feature of the central node in order to capture the neighborhood feature interactions by applying element-wise multiplication on every neighbor-neighbor pair. Equation (14) below illustrates an example of a pairwise neighborhood aggregation (PNA) function that can be implemented in a graph convolution layer of GCNN 201 in place of the mean aggregation functions:

$$\begin{matrix}{h}_{PNA}^{k} = {\sum }_{i = 1}^{{N}_{k}} {\sum }_{j = i + 1}^{{N}_{k}} {q}_{i}^{k} ⊙ {q}_{j}^{k} , \\ \frac{1}{2} ( {( {\sum }_{i = 1}^{{N}_{k}} {\sum }_{j = 1}^{{N}_{k}} {q}_{i}^{k} ⊙ {q}_{j}^{k} )}^{2} - {\sum }_{i = 1}^{{N}_{k}} {q}_{i}^{k} ⊙ {q}_{j}^{k} ) , \\ \frac{1}{2} ( {\sum }_{i = 1}^{{N}_{k}} {q}_{i}^{k} {\sum }_{j = 1}^{{N}_{k}} {q}_{j}^{k} - {\sum }_{i = 1}^{{N}_{k}} {q}_{i}^{{k}^{2}} ) , \\ \frac{1}{2} ( {( {\sum }_{i = 1}^{{N}_{k}} {q}_{i}^{k} )}^{2} - {\sum }_{i = 1}^{{N}_{k}} {( {q}_{i}^{k} )}^{2} )\end{matrix} . \qquad Eq . ( 14 )$$

Where: qᵢ and qⱼ are the ith and jth row of the neighborhood embedding matrixQ^{k}∈R^{N}^{ₖ}^{*d} at layer k. PNA can be computed in linear complexity O(N).

Direct first-order neighborhood information (a coraser summary of the entire neighborhood) is preserved by a sum aggregator as in the above described embodiment. These two forms of neighborhood information are concatenated and the resulting vector passed through a standard multilayer perception to generate the local neighborhood embedding h_{N}_{ᵤ}_{^{k}}^{k} (equation 15):

$${h}_{SUM}^{k} = {\sum }_{i}^{{N}_{k}} {q}_{i}^{k} , \qquad ( Eq . 15 )$$

$${h}_{{𝒩}_{( u )}^{k}}^{k} = σ ( {W}_{u , 1}^{k} [ {h}_{PNA}^{k} ; {h}_{SUM}^{k} ] ) .$$

where: [;] represents concatenation, σ(·) is the tanh activation function, and W_{u,3}^{k} is the layer-k (user) aggregator weight (shared across all central user nodes at layer k).

After the aggregation process, every central node is assigned a new embedding by combining its aggregated neighborhood vector with the central node embedding vector itself. The layer-k embedding of the target user u can be represented as (equation 16):

hᵤ^{k}=σ(W_{u,3}^{k}[σ(W_{u,2}^{k}hᵤ⁰); [symbol] ]),hᵤ⁰=eᵤ, Eq. (16)

where eᵤ is the initial embedding for target node 0, W_{u,2}^{k} is the weight matrix for central node transformation, and W_{u,3}^{k} is the weight matrix for the center-neighbor transformation function at layer k. The same operations (with different weight matrices) are applied to generate the layer k item embedding hᵥ^{k} of item v.

Processing System

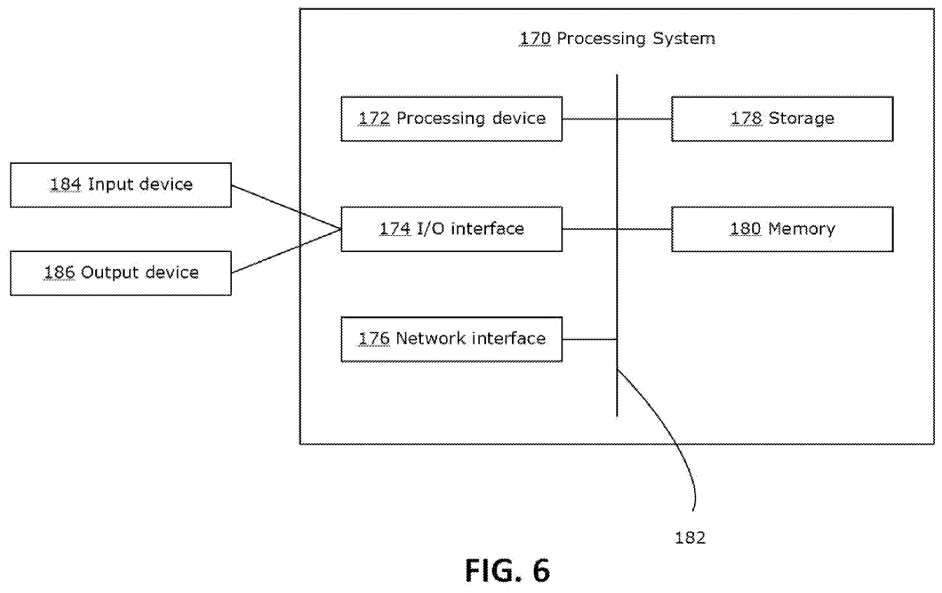

In example embodiments, multi-GCCF system 200 is computer implemented using one or more computing devices. FIG. 6 is a block diagram of an example processing system 170, which may be used in a computer device to execute machine executable instructions to implement multi-GCN system 200. Other processing units suitable for implementing embodiments described in the present disclosure may be used, which may include components different from those discussed below. Although FIG. 6 shows a single instance of each component, there may be multiple instances of each component in the processing unit 170.

The processing system 170 may include one or more processing devices 172, such as a processor, a microprocessor, a central processing unit, a hardware accelerator a graphics processing unit, a neural processing unit, a tensor, processing unit, an application-specific integrated circuit (ASIC), a field-programmable gate array (FPGA), a dedicated logic circuitry, or combinations thereof. The processing device 170 performs the computations described herein. The processing system 170 may also include one or more input/output (I/O) interfaces 174, which may enable interfacing with one or more appropriate input devices 184 and/or output devices 186. The processing system 170 may include one or more network interfaces 176 for wired or wireless communication with a network.

The processing system 170 may also include one or more storage units 178, which may include a mass storage unit such as a solid state drive, a hard disk drive, a magnetic disk drive and/or an optical disk drive. The processing system 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such as to carry out examples described in the present disclosure. The memory(ies) 180 may include other software instructions, such as for implementing an operating system and other applications/functions.

There may be a bus 182 providing communication among components of the processing system 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure are incorporated herein by reference.

1. A computer implemented method for processing a bipartite graph that comprises a plurality of first nodes of a first node type, and a plurality of second nodes of a second type, comprising:
generating a target first node embedding for a target first node based on features of second nodes and first nodes that are within a multi-hop first node neighbourhood of the target first node, the target first node being selected from the plurality of first nodes of the first node type;
generating a target second node embedding for a target second node based on features of first nodes and second nodes that are within a multi-hop second node neighbourhood of the target second node, the target second node being selected from the plurality of second nodes of the second node type; and
determining a relationship between the target first node and the target second node based on the target first node embedding and the target second node embedding.

2. The method of claim 1 wherein:
generating the target first node embedding comprises:
for each of a plurality of second nodes included within the first node neighbourhood: aggregating features for first nodes that are direct neighbours of the second node within the first node neighbourhood, and mapping the aggregated features to a respective second node embedding;
aggregating the second node embeddings for the plurality of second nodes included within the first node neighbourhood; and
mapping the aggregated second node embeddings to generate the target first node embedding; and
generating the target second node embedding comprises:
for each of a plurality of first nodes included within the second node neighbourhood: aggregating features for second nodes that are direct neighbours of the first node within the second node neighbourhood, and mapping the aggregated features to a respective first node embedding;
aggregating the first node embeddings for the plurality of first nodes included within the second node neighbourhood; and
mapping the aggregated first node embeddings to generate the target second node embedding.

3. The method of claim 2 wherein each aggregating and mapping is performed using a respective function that is defined by a respective set of learnable parameters, wherein the aggregating and mapping is performed iteratively in respect of the target first node and the target second node and the learnable parameters updated to optimize an objective function calculated based on the target first node embedding and the target second node embedding.

4. The method of claim 3 wherein the functions are implemented within a graphic convolution network (GCN) and the respective sets of learnable parameters are weight matrices.

5. The method of claim 1, comprising:
defining the first node neighbourhood of the target first node by randomly sampling the bipartite graph to: select a second node subset from second nodes that are direct neighbours of the target first node, and select respective subsets of first nodes from first nodes that are direct neighbours of each of the second nodes of the second node subset; and
defining the second node neighbourhood of the target second node by randomly sampling the bipartite graph to: select a first node subset from first nodes that are direct neighbours of the target second node, and select respective subsets of second nodes from second nodes that are direct neighbours of each of the first nodes of the first node subset.

6. The method of claim 5 wherein respective predefined hyper-parameters define respective sizes of the second node subset, the respective subsets of first nodes, the first node subset and the respective subsets of second nodes.

7. The method of claim 1, comprising:
determining, based on the bipartite graph, first node to first node relationship information and constructing a first node graph that includes first nodes, including the target first node, from the bipartite graph and the first node to first node relationship information;
generating a first node-first node embedding for the target first node based on the first node graph;
determining, based on the bipartite graph, second node to second node relationship information and constructing a second node graph that includes second nodes, including the target second node, from the bipartite graph and the second node to second node relationship information;
generating a second node-second node embedding for the target second node based on the second node graph;
wherein the relationship between the target first node and the target second node is determined also based on the first node-first node embedding and the second node-second node embedding.

8. The method of claim 7 wherein:
determining the first node to first node relationship information comprises determining the presence or absence of a direct neighbor relationship between respective pairs of the first nodes based on calculating pairwise cosine similarities between the respective pairs of the first nodes, and
determining the second node to second node relationship information comprises determining the presence or absence of a direct neighbor relationship between respective pairs of the second nodes based on calculating pairwise cosine similarities between the respective pairs of second nodes.

9. The method of claim 8 wherein:
generating the first node-first node embedding for the target first node comprises using a first node-first node aggregating function having learnable parameters to aggregate features of the first nodes that are direct neighbours of the target first node in the first node graph, and
generating the second node-second node embedding for the target second node comprises using a second node-second node aggregating function having learnable parameters to aggregate features of the second nodes that are direct neighbours of the target second node in the second node graph.

10. The method of claim 7 comprising:
generating, using a first skip connection transformation function having learnable parameters, a target first node skip connection embedding based on an initial target first node embedding; and
generating, using a second skip connection transformation function having learnable parameters, a target second node skip connection embedding based on an initial target second node embedding,
wherein the relationship between the target first node and the target second node is determined also based on the target first node skip connection and the target second node skip connection.

11. The method of claim 10 comprising:
determining a first node embedding by fusing the target first node embedding, the first node-first node embedding and the first node skip connection embedding;
determining a second node embedding by fusing the target second node embedding, the second node-second node embedding and the second node skip connection embedding;
the relationship between the target first node and the target second node being determined based on the first node embedding and the second node embedding.

12. The method of claim 1 wherein the first nodes represent users and the second nodes represent items, the bipartite graph includes historical user-item interaction data, and the method further comprising determining an item recommendation for a user represented by the target node based on the determined relationship between the target first node and the target second node.

13. A graph convolution network (GCN) for processing a bipartite graph that comprises a plurality of first nodes of a first node type, and a plurality of second nodes of a second type, the CGN being configured to:
generate a target first node embedding for a target first node based on features of second nodes and first nodes that are within a multi-hop first node neighbourhood of the target first node, the target first node being selected from the plurality of first nodes of the first node type;
generate a target second node embedding for a target second node based on features of first nodes and second nodes that are within a multi-hop second node neighbourhood of the target second node, the target second node being selected from the plurality of second nodes of the second node type; and
determine a relationship between the target first node and the target second node based on the target first node embedding and the target second node embedding.

14. The CGN of claim 13 wherein the CGN comprises:
a first node first aggregating function configured to aggregate, for each of a plurality of second nodes included within the first node neighbourhood, features for first nodes that are direct neighbours of the second node within the first node neighbourhood;
a first node first mapping function configured to map, for each of the plurality of second nodes, the features aggregated for the second node to a respective second node embedding;
a first node second aggregating function configured to aggregate the second node embeddings for the plurality of second nodes included within the first node neighbourhood;
a first node second mapping function configured to map the aggregated second node embeddings to generate the target first node embedding;
a second node first aggregating function configured to aggregate, for each of a plurality of first nodes included within the second node, features for second nodes that are direct neighbours of the first node within the second node neighbourhood;
a second node first mapping function configured to map, for each of the plurality of first nodes, the features aggregated for the first node to a respective first node embedding;
a second node second aggregating function configured to aggregate the first node embeddings for the plurality of first nodes included within the second node neighbourhood; and
a second node second mapping function configured to map the aggregated first node embeddings to generate the target second node embedding.

15. The GCN of claim 14 wherein GCN is configured to implement an objective loss calculation based on the target first node embedding and the target second node embedding, the functions are each defined by a respective set of learnable parameters, and the CGN is configured to learn the parameters iteratively to determine learnable parameters that optimize the objective loss calculation.

16. The GCN of claim 14, the CGN being configured to implement:
a first node neighbourhood sampling function configured to define the first node neighbourhood of the target first node by randomly sampling the bipartite graph to: select a second node subset from second nodes that are direct neighbours of the target first node, and select respective subsets of first nodes from first nodes that are direct neighbours of each of the second nodes of the second node subset; and
a second node neighbourhood sampling function configured to define the second node neighbourhood of the target second node by randomly sampling the bipartite graph to: select a first node subset from first nodes that are direct neighbours of the target second node, and select respective subsets of second nodes from second nodes that are direct neighbours of each of the first nodes of the first node subset.

17. The GCN of claim 13, the CGN being configured to implement:
a first node-first node graph construction function configured to determine, based on the bipartite graph, first node to first node relationship information and construct a first node graph that includes first nodes, including the target first node, from the bipartite graph and the first node to first node relationship information;
a first node-first node embedding function configured to generate a first node-first node embedding for the target first node based on the first node graph;
a second node-second node graph construction function configured to determine, based on the bipartite graph, second node to second node relationship information and construct a second node graph that includes second nodes, including the target second node, from the bipartite graph and the second node to second node relationship information; and
a second node-second node embedding function configured to generate a second node-second node embedding for the target second node based on the second node graph;
a fusing operation is configured to fuse the first node-first node embedding with the target first node embedding and the second node-second node embedding with the target second node embedding.

18. The GCN of claim 17 wherein:
the first node-first node graph construction function is configured to determine the first node to first node relationship information by determining the presence or absence of a direct neighbor relationship between respective pairs of the first nodes based on calculating pairwise cosine similarities between the respective pairs of the first nodes, and
the second node-second node graph construction function is configured to determine second node to second node relationship information by determining the presence or absence of a direct neighbor relationship between respective pairs of the second nodes based on calculating pairwise cosine similarities between the respective pairs of second nodes.

19. The GCN of claim 17 wherein:
the first node-first node embedding function comprises a first node-first node aggregating function having learnable parameters to aggregate features of the first nodes that are direct neighbours of the target first node in the first node graph, and
the second node-second node embedding function comprises a second node-second node aggregating function having learnable parameters to aggregate features of the second nodes that are direct neighbours of the target second node in the second node graph.

20. A multi-graph convolution collaborative filtering system implemented in multiple layers of a multi-layer graph convolution neural network for learning about user-item preferences from a bipartite graph that includes user nodes, item nodes and interaction data about historical interactions between user nodes and item nodes, the system comprising:
a bipartite-graph convolution network configured to independently generate a user embedding for a target user node and an item embedding for a target item node based on the bipartite graph;
a multi-graph encoder configured to: construct a user-user graph representing similarities between user nodes included in the bipartite graph and generate an user-user embedding for the target user node based on the user-user graph; and construct an item-item graph representing similarities between item nodes included in the bipartite graph and generate an item-item embedding for the target item node based on the item-item graph; and
a fusing module configured to perform a first fusion operation to fuse the user embedding, user-user embedding, and to perform a second fusion operation to fuse the item embedding and item-item embedding to output information that represents a relationship between the target user node and the target item node.
